(19) United States
(12) Patent Application Publication
(10) Pub. No.: US 2015/0304914 A1
(43) Pub. Date: Oct. 22, 2015

(54) MOBILE COMMUNICATION METHOD, RADIO BASE STATION, AND MOBILE STATION

(71) Applicant: NTT DOCOMO, INC., Tokyo (JP)

(72) Inventors: Tooru Uchino, Tokyo (JP); Sadayuki Abeta, Tokyo (JP); Hiroyuki Ishii, Palo Alto, CA (US)

(73) Assignee: NTT DOCOMO, INC., Tokyo (JP)

(21) Appl. No.: 14/424,080

(22) PCT Filed: Aug. 19, 2013
(86) PCT No.: PCT/JP2013/072045

§ 371 Date: Feb. 26, 2015

(30) Foreign Application Priority Data
Aug. 29, 2012 (JP) 2012-188688

(51) Int. Cl. H04W 36/04; H04W 16/32; H04W 74/08; H04W 76/02

(52) U.S. Cl. CPC H04W 36/04; H04W 76/021; H04W 16/32; H04W 74/0833

(57) ABSTRACT

A C-RNTIₚₕ in a phantom cell is allocated to a mobile station UE after the mobile station UE is identified. A mobile communication method according to the present invention includes the steps of: when a cell #10 formed by linking multiple small cells is established in a manner as to at least partially overlap a coverage area of a cell #1 under control of a radio base station eNB#1, notifying a mobile station UE#1 in communication in the cell #1 of a C-RNTIₚₕ in the cell #10 by the radio base station eNB#1 by sending “RRC connection reconfiguration”; and setting, by the mobile station UE#1, the C-RNTIₚₕ in the cell #10 in addition to a C-RNTI_{macro} in the cell #1.

### TECHNICAL FIELD

The present invention relates to a mobile communication method, a radio base station, and a mobile station.

### BACKGROUND ART

In LTE (Long Term Evolution), a radio base station eNB is configured to transmit/receive data to and from a mobile station UE performing communications in a cell under the control thereof, with a C-RNTI (Cell-Radio Network Temporary Identify) allocated to the mobile station UE as illustrated in FIG. 6 (see, non patent document 1).

The C-RNTI is allocated on a cell-by-cell basis. In LTE, as illustrated in FIG. 6, a same C-RNTI cannot be allocated to a mobile station UE#1 and a mobile station UE#2 which perform communications in a same cell #A, and a same C-RNTI can be allocated to a mobile station UE#1 (or a mobile station UE#2) and a mobile station UE#3 which perform communications in different cells #A/#B.

In addition, the radio base station eNB is configured to assign resources for transmitting downlink data or uplink data by using the C-RNTI allocated to the mobile station UE.

Meanwhile, in the “Rel-12 workshop” of 3GPP, many proposals on “Small cell enhancement” have been made as topics of FRA (Future Radio Access).

In such proposals, a concept of “Phantom cell” has been discussed.

As illustrated in FIG. 7, unlike a conventional macro cell, a phantom cell can cover a wider area by linking many “small cells” to form one large cell.

### PRIOR ART DOCUMENT

### Non-Patent Document

Non-patent document 1: 3GPP TS36.300

### SUMMARY OF THE INVENTION

Here, under the environment where a coverage area of a phantom cell and coverage areas of macro cells at least partially overlap each other as illustrated in FIG. 7, it is presumed that a C-RNTIₚₕ in the phantom cell is allocated to a mobile station in addition to a C-RNTI_{macro} in the macro cell.

The C-RNTI_{macro} in the macro cell is allocated in a “Contention based RA (Random Access) Procedure” or a handover procedure.

However, in existing LTE, a radio base station eNB has to first identify a mobile station UE and then allocate a C-RNTIₚₕ in a phantom cell to the mobile station UE.

This poses a problem that a C-RNTIₚₕ in a phantom cell is difficult to allocate in a “Contention based RA procedure” in the same way as a C-RNTI_{macro} in a macro cell.

In addition, existing LTE has another problem that allocation of a C-RNTIₚₕ in a phantom cell in a handover procedure, similar to the case of a C-RNTI_{macro} in a macro cell, is not preferable due to occurrence of short interruption of data transmission/reception when the handover procedure is activated.

Hence, the present invention has been made with a view to the above-described problems. Accordingly, an objective of the invention is to provide a mobile communication method, a radio base station, and a mobile station, which enable a C-RNTIₚₕ in a phantom cell to be allocated to a mobile station UE once the mobile station UE is identified.

A first feature of the present invention is summarized as a mobile communication method, including the step of: when a phantom cell formed by linking multiple small cells is established in a manner as to at least partially overlap a coverage area of a macro cell under control of a radio base station, notifying a mobile station in communication in the macro cell of a cell identifier in the phantom cell by the radio base station by sending a connection reconfiguration signal; and setting, by the mobile station, the cell identifier in the phantom cell in addition to a cell identifier in the macro cell.

A second feature of the present invention is summarized as a mobile communication method, including the step of: when a phantom cell formed by linking multiple small cells is established in a manner as to at least partially overlap a coverage area of a macro cell under control of a radio base station, and when a distance between a first mobile station and a second mobile station in which a same cell identifier is set and which are in communication in the macro cell becomes shorter than a threshold, notifying the first mobile station of a cell identifier in the phantom cell by the radio base station by sending a connection reconfiguration signal; and setting, by the first mobile station, the notified cell identifier in the phantom cell in addition to a cell identifier in the macro cell.

A third feature of the present invention is summarized as a mobile communication method, including the step of: when a phantom cell formed by linking multiple small cells is established in a manner as to at least partially overlap a coverage area of a macro cell under control of a radio base station, starting a non-contention based random access procedure by a mobile station in communication in the macro cell and by the radio base station; notifying the mobile station of a cell identifier in the phantom cell by sending a random access response signal by the radio base station in the non-contention based random access procedure; and setting, by the mobile station, the cell identifier in the phantom cell in addition to a cell identifier in the macro cell.

A fourth feature of the present invention is summarized as a mobile communication method, including the step of: when a phantom cell formed by linking multiple small cells is established in a manner as to at least partially overlap a coverage area of a macro cell under control of a radio base station, and when a distance between a first mobile station and a second mobile station in which a same cell identifier is set and which are in communication in the macro cell becomes shorter than a threshold, starting a non-contention based random access procedure by the radio base station and the first mobile station; notifying the first mobile station of a cell identifier in the phantom cell by sending a random access response signal by the radio base station in the non-contention based random access procedure; and setting, by the first mobile station, the notified cell identifier in the phantom cell in addition to a cell identifier in the macro cell.

A fifth feature of the present invention is summarized as a radio base station, including: a transmission unit configured to, when a phantom cell formed by linking multiple small cells is established in a manner as to at least partially overlap a coverage area of a macro cell under control of a radio base station, notify a mobile station in communication in the macro cell of a cell identifier in the phantom cell by sending a connection reconfiguration signal.

A sixth feature of the present invention is summarized as a radio base station, including: a transmission unit configured to, when a phantom cell formed by linking multiple small cells is established in a manner as to at least partially overlap a coverage area of a macro cell under control of a radio base station, and when a distance between a first mobile station and a second mobile station in which a same cell identifier is set and which are in communication in the macro cell becomes shorter than a threshold, notify the first mobile station of a cell identifier in the phantom cell by sending a connection reconfiguration signal.

A seventh feature of the present invention is summarized as a radio base station, including: a transmission unit configured to, when a phantom cell formed by linking multiple small cells is established in a manner as to at least partially overlap a coverage area of a macro cell under control of a radio base station, start a non-contention based random access procedure with a mobile station in communication with the radio base station in the macro cell and notify the mobile station of a cell identifier in the phantom cell by sending a random access response signal in the non-contention based random access procedure.

A eighth feature of the present invention is summarized as a radio base station, including: a transmission unit configured to, when a phantom cell formed by linking multiple small cells is established in a manner as to at least partially overlap a coverage area of a macro cell under control of a radio base station, and when a distance between a first mobile station and a second mobile station in which a same cell identifier is set and which are in communication in the macro cell becomes shorter than a threshold, start a non-contention based random access procedure with the first mobile station and notify the first mobile station of a cell identifier in the phantom cell by sending a random access response signal in the non-contention based random access procedure.

A ninth feature of the present invention is summarized as a mobile station, including: a reception unit configured to, when a phantom cell formed by linking multiple small cells is established in a manner as to at least partially overlap a coverage area of a macro cell under control of a radio base station, and when the mobile station is in communication in the macro cell, acquire a cell identifier in the phantom cell from the radio base station via a connection reconfiguration signal; and a setting unit configured to set the cell identifier in the phantom cell in addition to a cell identifier in the macro cell.

A tenth feature of the present invention is summarized as a mobile station, including: a reception unit configured to, when a phantom cell formed by linking multiple small cells is established in a manner as to at least partially overlap a coverage area of a macro cell under control of a radio base station, when the mobile station is in communication in the macro cell, and when a distance to another mobile station, in which the same cell identifier as that of the mobile station is set, becomes shorter than a threshold, acquire a cell identifier in the phantom cell from the radio base station via a connection reconfiguration signal; and a setting unit configured to set the notified cell identifier in the phantom cell in addition to a cell identifier in the macro cell.

A eleventh feature of the present invention is summarized as a mobile station, including: a reception unit configured to, when a phantom cell formed by linking multiple small cells is established in a manner as to at least partially overlap a coverage area of a macro cell under control of a radio base station, and when the mobile station is in communication in the macro cell, start a non-contention based random access procedure with the radio base station, and acquire a cell identifier in the phantom cell from the radio base station via a radon access response signal in the non-contention based random access procedure; and a setting unit configured to, set the cell identifier in the phantom cell in addition to a cell identifier in the macro cell.

A twelfth feature of the present invention is summarized as a mobile station, including: a reception unit configured to, when a phantom cell formed by linking multiple small cells is established in a manner as to at least partially overlap a coverage area of a macro cell under control of a radio base station, when the mobile station is in communication in the macro cell, and when a distance to another mobile station, in which the same cell identifier as that of the mobile station is set, becomes shorter than a threshold, start a non-contention based random access procedure with the radio base station and acquire a cell identifier in the phantom cell from the radio base station via a random access response signal in the non-contention based random access procedure; and a setting unit configured to set the notified cell identifier in the phantom cell in addition to a cell identifier in the macro cell.

### BRIEF DESCRIPTION OF THE DRAWINGS

FIG. 1 is an overall configuration diagram of a mobile communication system according to a first embodiment of the present invention.

FIG. 2 is a functional block diagram of a radio base station according to the first embodiment of the present invention.

FIG. 3 is a functional block diagram of a mobile station according to the first embodiment of the present invention.

FIG. 4 is a sequential diagram illustrating an operation of the mobile communication system according to the first embodiment of the present invention.

FIG. 5 is a sequential diagram illustrating an operation of the mobile communication system according to the first embodiment of the present invention.

FIG. 6 is a diagram for illustrating a conventional technology.

FIG. 7 is a diagram for illustrating the conventional technology.

### MODE FOR CARRYING OUT THE INVENTION

(Mobile Communication System According to the First Embodiment of the Present Invention)

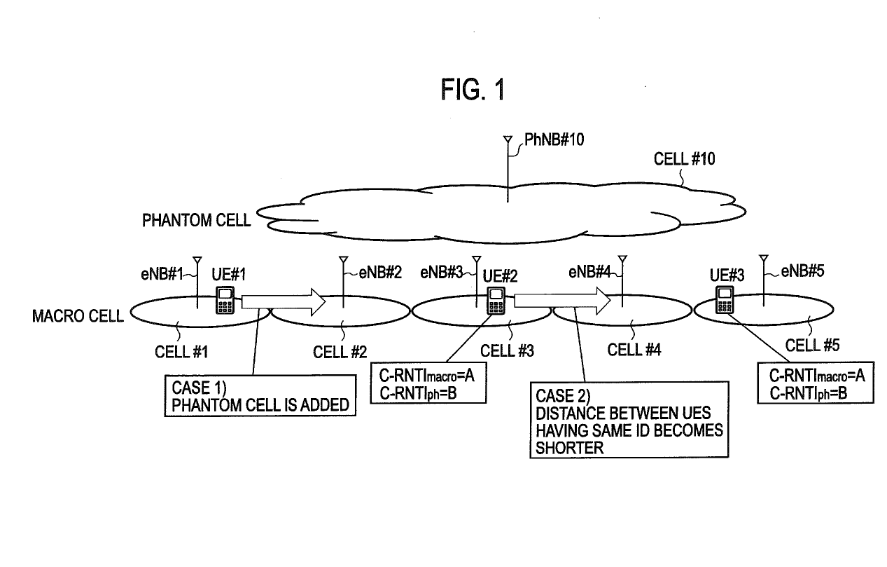

Described by referring to FIGS. 1 to 5 is a mobile communication system according to a first embodiment of the present invention.

As illustrated in FIG. 1, a mobile communication system according to the present embodiment is the LTE mobile communication system, which includes a radio base station PhNB#1 configured to manage a cell #10, a radio base station eNB#1 configured to manage a cell #1, a radio base station eNB#2 configured to manage a cell #2, a radio base station eNB#3 configured to manage a cell #3, a radio base station eNB#4 configured to manage a cell #4, and a radio base station eNB#5 configured to manage a cell #5.

Here, the cell #10 is a phantom cell formed by linking multiple small cells and the cells #1 to #5 are macro cells.

As illustrated in FIG. 1, a coverage area of the cell #10 and coverage areas of the cells #1 to #5 are deployed to at least partially overlap each other.

In the mobile communication system according to the present embodiment, a same C-RNTIₚₕ can be allocated to multiple mobile stations UE in the cell #10.

On the other hand, in the mobile communication system according to the present embodiment, a same C-RNTIₚₕ cannot be allocated to multiple mobile stations UE in the cells #1 to #5.

In the mobile communication system according the present embodiment, multiple C-RNTIs (in other words, C-RNTI_{macro} and C-RNTIₚₕ) can be allocated to one mobile station UE.

The description is given to the following two cases in the present embodiment: case 1 where the cell #10 as a phantom cell is added to a mobile station UE which is in communication in the cell #1 as a macro cell; and case 2 where a mobile station UE#2 which is in communication in the cell #10 comes close to a mobile station UE#5 having the same C-RNTIs (C-RNTI_{macro}=A and C-RNTIₚₕ=B).

The configurations of the radio base stations eNB#1 to eNB#5 are basically same, and the configuration of a radio base station eNB as a representative is described.

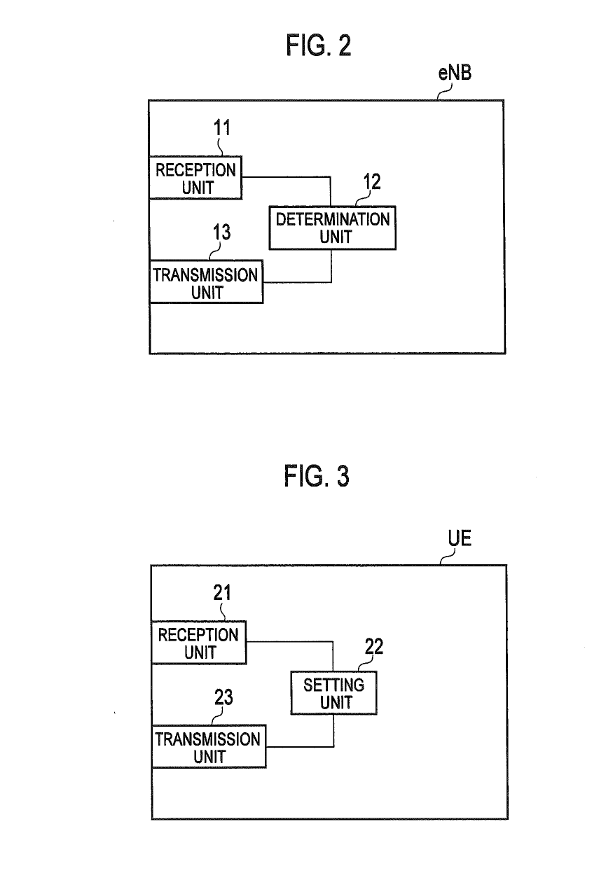

As illustrated in FIG. 2, the radio base station eNB#1 according to the present embodiment includes a reception unit 11, a determination unit 12, and a transmission unit 13.

The reception unit 11 is configured to receive various kinds of signals from the mobile station UE in the cell #1 and the radio base stations eNB#10/eNB#2 to #5. The transmission unit 13 is configured to transmit various kinds of signals to the mobile station UE in the cell #1 and the radio base stations eNB#10/eNB#2 to #5.

The determination unit 12 is configured to determine that a new C-RNTIₚₕ of the cell #10 is allocated to the mobile stations UE#1 to UE#3 in the case 1 or 2.

Specifically, as illustrated in FIG. 1, the determination unit 12 determines to allocate the C-RNTIₚₕ of the cell #10 to the mobile station UE which is in communication in the cell #1 when the above-described cell #10 is established (in other words, in the case 1).

In addition, when the cell #10 is established for the mobile station UE#2, and when a distance to another mobile station UE in which the same C-RNTIₚₕ as that of mobile station UE#2 is set and which is in communication in the cell #4/#5 becomes shorter than a predetermined threshold (in other words, in the case 2) as illustrated in FIG. 1, the determination unit 12 determines to allocate the C-RNTIₚₕ of the cell #10 to the mobile station UE#2 which is in communication in the cell #4 in order to avoid a collision between the mobile stations UE.

Instead, the determination unit 12 may determine to allocate the C-RNTIₚₕ of the cell #10 to the mobile station UE#3.

In addition, in such a case, the determination unit 12 may determine to allocate a new C-RNTI_{macro} in the cell #4, in place of allocating the C-RNTIₚₕ of the cell #10, to the mobile station UE #2 which is in communication in the cell #4.

In the case 1 or 2, the transmission unit 13 may notify the mobile stations UE#1 to UE#3 of the C-RNTIₚₕ in the cell #10 (or the C-RNTI_{macro} in the cell #4) by sending a “RRC connection reconfiguration.”

At this time, the notification may be notified together with the “RRC connection reconfiguration” which makes such instructions as addition or deletion of bearer and addition of phantom cell.

Alternatively, in the case 1 or 2, the transmission unit 13 may notify the mobile stations UE#1 to UE#3 of the C-RNTIph of the cell #10 (or C-RNTI_{macro} in the cell #4) in a “Non-connection RA procedure.”

The configurations of the mobile stations UE#1 to UE#3 according to the present embodiment are basically same, and the configuration of a mobile station UE as a representative is described.

As illustrated in FIG. 3, the mobile station UE according to the present embodiment includes a reception unit 21, a setting unit 22, and a transmission unit 23.

The reception unit 21 is configured to receive various kinds of signals from the radio base stations PhNB#10/eNB#1/eNB#2/eNB#3. The transmission unit 23 is configured to transmit various kinds of signals to the radio base stations PhNB#10/eNB#1/eNB#2/eNB#3.

For example, the reception unit 21 receives the C-RNTIₚₕ and C-RNTI_{macro} allocated to the mobile station UE from the radio base stations eNB#1 to eNB#5.

Specifically, as illustrated in FIG. 1, the reception unit 21 acquires the C-RNTIₚₕ in the cell #10 from the radio base station eNB#1 when the mobile station US is in communication in the cell #1, and when the cell #10 is established (in other words, in the case 1).

Also, the reception unit 21 acquires the C-RNTIₚₕ in the cell #10 from the radio base station eNB#4 when the mobile station UE is in communication in the cell #1, and when a distance to another mobile station UE in which the same C-RNTIₚₕ as that of the mobile station UE is set becomes shorter than a threshold (in other words, in the case 2) as illustrated in FIG. 1.

Here, the reception unit 21 may acquire the C-RNTIₚₕ in the cell #10 via the “RRC connection reconfiguration” or acquire the C-RNTIₚₕ in the cell #10 via a “RA response” which is received in the “Non-contention RA procedure.”

The setting unit 22 is configured to set the C-RNTIₚₕ acquired by the reception unit 21 via the “RRC connection reconfiguration” or in the “Non-contention RA procedure” as a C-RNTIₚₕ allocated to the mobile station UE in the cell #10.

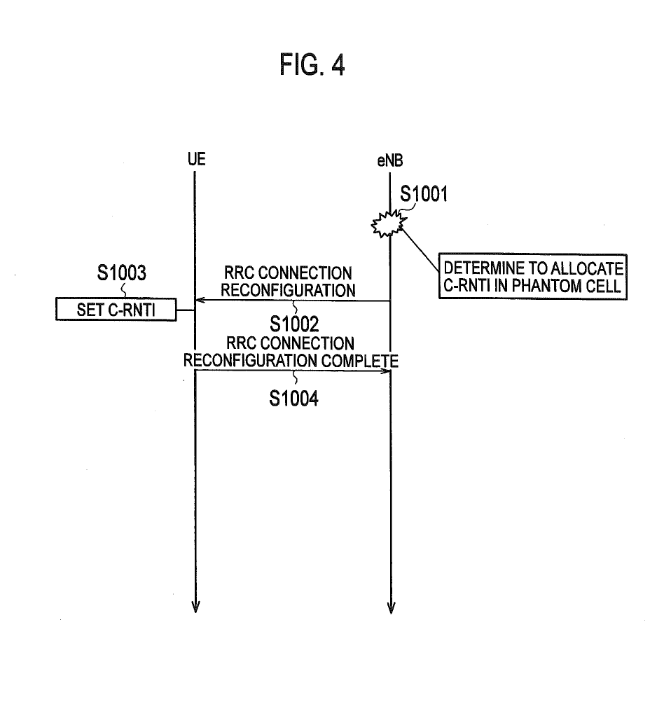

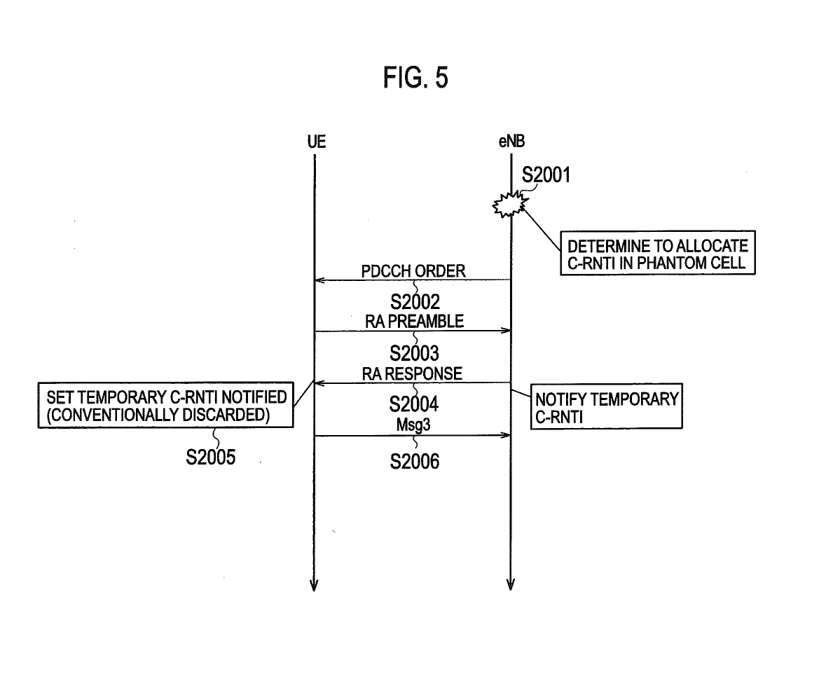

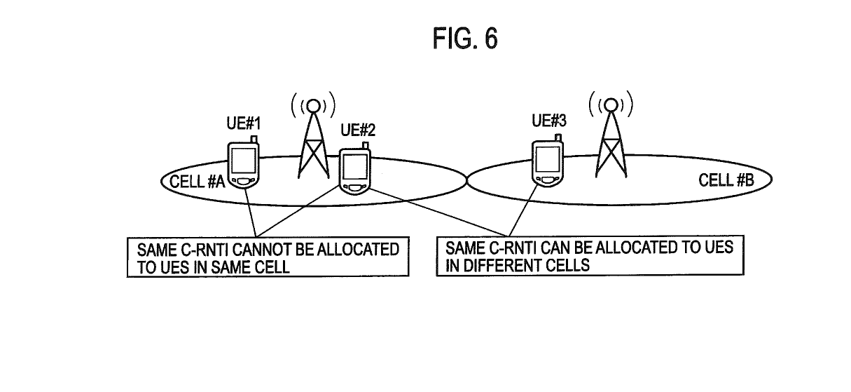

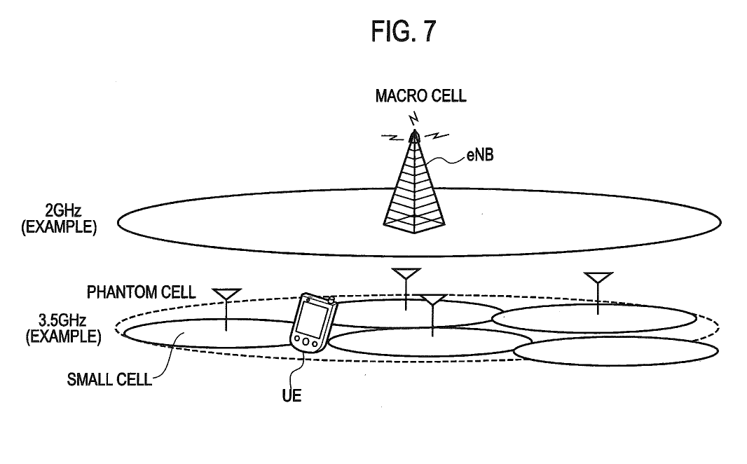

Described hereinafter by referring to FIGS. 4 and 5 is an operation of the mobile communication system according to the present embodiment.

Firstly, described by referring to FIG. 4 is exemplary operation 1 of the mobile communication system according to the present embodiment.

As illustrated in FIG. 4, when determining to add a phantom cell to mobile station UE which is in communication in a cell under control of a radio base station eNB at step S1001, the radio base station eNB transmits a “RRC Connection reconfiguration” including a C-RNTIₚₕ allocated to the mobile station UE in the phantom cell at step S1002.

The mobile station UE sets the C-RNTIₚₕ included in the received “RRC Connection reconfiguration” as a C-RNTIₚₕ allocated to the mobile station UE in the phantom cell at step S1003, and transmits a “RRC Connection reconfiguration complete” to the radio base station eNB at step S1004.

The “RRC Connection reconfiguration” may include an identifier of a cell which is associated with the C-RNTI to be allocated or an identifier of the radio base station eNB from which the identifier of the cell is removed.

Secondly, described by referring to FIG. 5 is the exemplary operation 2 of the mobile station system according to the present embodiment.

As illustrated in FIG. 5, when the radio base station eNB determines to add a phantom cell to a mobile station UE in communication in a cell under control of the radio base station eNB at step S2001, the radio base station eNB transmits a “PDCCH order” to the mobile station UE to start a “Non-contention RA procedure” with the mobile station UE at step S2002.

At step S2003, the mobile station UE transmits a “RA preamble” to the radio base station eNB.

At step S2004, the radio base station eNB transmits a “RA response” including the C-RNTIₚₕ allocated to the mobile station UE in the phantom cell as “temporary C-RNTI” to the mobile station UE.

The mobile station UE set “temporary C-RNTI” included in “RA response” which is conventionally discarded as the C-RNTIₚₕ allocated to the mobile station UE in the phantom cell at step S2005, and transmits “MSG3 (PUSCH corresponding to a “UL grant” instructed by the “RA response”)” to the radio base station eNB at step S2006.

The above-described non-contention based RA procedure may be implemented in any cell to which the mobile station UE is connected. Also, it may be implemented in a cell having different steps.

Here, the radio base station eNB may notify that a new C-RNTIₚₕ is allocated to the mobile station UE in the phantom cell in the “PDCCH order,” “RA response,” or the like.

With the above-described configuration, the radio base station eNB can notify the mobile station UE which is in communication in the cell under control of the radio base station eNB of a new C-RNTIₚₕ allocated to the mobile station UE in the phantom cell. Accordingly, in the case 1 and case 2, the C-RNTIₚₕ can be allocated with the recognition of a specific mobile station UE and short interruption of data transmission/reception along with the handover procedure can be avoided.

The features of the present embodiment may also be expressed as follows.

A first feature of the present embodiment is summarized as a mobile communication method, including the step of: when a cell #10 (phantom cell) formed by linking multiple small cells is established in a manner as to at least partially overlap a coverage area of a cell #1 (macro cell) under control of a radio base station eNB#1, notifying a mobile station UE#1 in communication in the cell #1 of a C-RNTIₚₕ (cell identifier) in the cell #10 by the radio base station eNB#1 by sending a “RRC connection reconfiguration (connection reconfiguration signal)”; and setting, by the mobile station UE#1, the C-RNTIₚₕ in the cell #10 in addition to a C-RNTI_{macro} in the cell #1.

A second feature of the present embodiment is summarized as a mobile communication method, including the step of: when a cell #10 formed by linking multiple small cells is established in a manner as to at least partially overlap a coverage area of a cell #4 under control of a radio base station eNB#4, and when a distance between a mobile station UE#2 (first mobile station) and a mobile station UE#3 (second mobile station) in which a same C-RNTI_{macro}/C-RNTIₚₕ is set and which are in communication in the cell #4/#5 becomes shorter than a threshold, notifying the mobile station UE#2 of a C-RNTIₚₕ in the cell #10 by the radio base station eNB#4 by sending a “RRC connection reconfiguration”; and setting, by the mobile station UE#2, the notified C-RNTIₚₕ in the cell #10 in addition to a C-RNTI_{macro} in the cell #4.

A third feature of the present embodiment is summarized as a mobile communication method, including the step of: when a cell #10 (phantom cell) formed by linking multiple small cells is established in a manner as to at least partially overlap a coverage area of a cell #1 (macro cell) under control of a radio base station eNB#1, starting a “Non-connection RA procedure (non-contention based random access procedure)” by a mobile station UE#1 in communication in the cell #1 and by the radio base station eNB#1; notifying the mobile station UE#1 of a C-RNTIₚₕ in the cell #10 by sending a “RA response (random access response signal)” by the radio base station eNB#1 in the “Non-connection RA procedure”; and setting, by the mobile station UE#1, the C-RNTIₚₕ in the cell #10 in addition to a C-RNTI_{macro} in the cell #1.

A fourth feature of the present embodiment is summarized as a mobile communication method, including the step of: when a cell #10 formed by linking multiple small cells is established in a manner as to at least partially overlap a coverage area of a cell #4 under control of a radio base station eNB#4, and when a distance between a mobile station UE#2 and a mobile station UE#3 in which a same C-RNTI_{macro}/C-RNTIₚₕ is set and which are in communication in the cell #4/#5 becomes shorter than a threshold, starting a “Non-connection RA procedure” by the radio base station eNB#4 and the mobile station UE#2; notifying the mobile station UE#2 of a C-RNTIₚₕ in the cell #10 by sending a “RA response” by the radio base station eNB#4 in the “Non-connection RA procedure”; and setting, by the mobile station UE#2, the notified C-RNTIₚₕ in the cell #10 in addition to a C-RNTI_{macro} in the cell #4.

A fifth feature of the present embodiment is summarized as a radio base station eNB#1, including: a transmission unit 13 configured to, when a cell #10 formed by linking multiple small cells is established in a manner as to at least partially overlap a coverage area of a cell #1 under control of a radio base station eNB#1, notify a mobile station UE#1 in communication in the cell #1 of a C-RNTIₚₕ in the cell #10 by sending a “RRC connection reconfiguration.”

A sixth feature of the present embodiment is summarized as a radio base station eNB#4, including: a transmission unit 13 configured to, when a cell #10 formed by linking multiple small cells is established in a manner as to at least partially overlap a coverage area of a cell #4 under control of a radio base station eNB#4, and when a distance between a mobile station UE#2 and a mobile station UE#3 in which a same C-RNTI_{macro}/C-RNTIₚₕ is set and which are in communication in the cell #4/#5 becomes shorter than a threshold, notify the mobile station UE#2 of a C-RNTIₚₕ in the cell #10 by sending a “RRC connection reconfiguration.”

A seventh feature of the present embodiment is summarized as a radio base station eNB#1, including: a transmission unit 13 configured to, when a cell #10 formed by linking multiple small cells is established in a manner as to at least partially overlap a coverage area of a cell #1 under control of a radio base station eNB#1, start a “Non-connection RA procedure” with a mobile station UE#1 in communication with the radio base station eNB#1 in the cell #1 and notify the mobile station UE#1 of a C-RNTIₚₕ in the cell #10 by sending a “RA response” in the “Non-connection RA procedure.”

A eighth feature of the present embodiment is summarized as a radio base station eNB#4, including: a transmission unit 13 configured to, when a cell #10 formed by linking multiple small cells is established in a manner as to at least partially overlap a coverage area of a cell #4 under control of a radio base station eNB#4, and when a distance between a mobile station UE#2 and a mobile station UE#3 in which a same C-RNTI_{macro}/C-RNTIₚₕ is set and which are in communication in the cell #4/#5 becomes shorter than a threshold, start a “Non-connection RA procedure” with the mobile station UE#2 and notify the mobile station UE#2 of a C-RNTIₚₕ in the cell #10 by sending a “RA response” in the “Non-connection RA procedure.”

A ninth feature of the present embodiment is summarized as a mobile station UE#1, including: a reception unit 21 configured to, when a cell #10 formed by linking multiple small cells is established in a manner as to at least partially overlap a coverage area of a cell #1 under control of a radio base station eNB#1, and when the mobile station UE#1 is in communication in the cell #1, acquire a C-RNTIₚₕ in the cell #10 from the radio base station eNB#1 via a “RRC connection reconfiguration”; and a setting unit 22 configured to set the C-RNTIₚₕ in the cell #10 in addition to a C-RNTI_{macro} in the cell #1.

A tenth feature of the present embodiment is summarized as a mobile station UE#2, including: a reception unit 21 configured to, when a cell #10 formed by linking multiple small cells is established in a manner as to at least partially overlap a coverage area of a cell #4 under control of a radio base station eNB#4, when the mobile station UE#2 is in communication in the cell #4, and when a distance to another mobile station UE#3, in which the same C-RNTI_{macro}/C-RNTIₚₕ as that of the mobile station UE#2 is set, becomes shorter than a threshold, acquire a C-RNTIₚₕ in the cell #10 from the radio base station eNB#4 via a “RRC connection reconfiguration”; and a setting unit 22 configured to set the C-RNTIₚₕ in the cell #10 in addition to a C-RNTI_{macro} in the cell #4.

A eleventh feature of the present embodiment is summarized as a mobile station UE#1, including: a reception unit 21 configured to, when a cell #10 formed by linking multiple small cells is established in a manner as to at least partially overlap a coverage area of a cell #1 under control of a radio base station eNB#1, and when the mobile station UE#1 is in communication in the cell #1, start a “Non-connection RA procedure” with the radio base station eNB#1, and acquire a C-RNTIₚₕ in the cell #10 from the radio base station eNB#1 via a “RA response” in the “Non-connection RA procedure”; and a setting unit 22 configured to set the C-RNTIₚₕ in the cell #10 in addition to a C-RNTI_{macro} in the cell #1.

A twelfth feature of the present embodiment is summarized as a mobile station UE#2, including: a reception unit 21 configured to, when a cell #10 formed by linking multiple small cells is established in a manner as to at least partially overlap a coverage area of a cell #4 under control of a radio base station eNB#4, when the mobile station UE#2 is in communication in the cell #4, and when a distance to another mobile station UE#3, in which the same C-RNTI_{macro}/C-RNTIₚₕ as that of the mobile station UE#2 is set, becomes shorter than a threshold, start a “Non-connection RA procedure” with the radio base station eNB#4 and acquire a C-RNTIₚₕ in the cell #10 from the radio base station eNB#4 via a “RA response” in the “Non-connection RA procedure”; and a setting unit 22 configured to set the notified C-RNTIₚₕ in the cell #10 in addition to a C-RNTI_{macro} in the cell #4.

Here, the foregoing operations of the mobile stations UE#1 to UE#3 and the radio base stations eNB#1 to eNB#5, PhNB#10 may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile stations UE#1 to UE#3 and the radio base stations eNB#1 to eNB#5PhNB#10. Otherwise, the storage medium and the processor may be provided as discrete components inside the mobile stations UE#1 to UE#3 and the radio base stations eNB#1 to eNB#5, PhNB#10.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2012-188688 (filed on Aug. 29, 2012) is incorporated by reference in the present specification.

### INDUSTRIAL APPLICABILITY

As described above, the present invention can provide a mobile communication method, a radio base station, and a mobile station, which can allocate a C-RNTIₚₕ in a phantom cell after a mobile station is identified.

### EXPLANATION OF REFERENCE NUMERALS

eNB#1 to eNB#5, PhNB#10 radio base station
UE mobile station
11, 22 reception unit
12 determination unit
13, 23 transmission unit
22 setting unit

1. A mobile communication method, comprising the step of:
when a phantom cell formed by linking a plurality of small cells is established in a manner as to at least partially overlap a coverage area of a macro cell under control of a radio base station, notifying a mobile station in communication in the macro cell of a cell identifier in the phantom cell by the radio base station by sending a connection reconfiguration signal; and
setting, by the mobile station, the cell identifier in the phantom cell in addition to a cell identifier in the macro cell.

2. A mobile communication method, comprising the step of:
when a phantom cell formed by linking a plurality of small cells is established in a manner as to at least partially overlap a coverage area of a macro cell under control of a radio base station, and when a distance between a first mobile station and a second mobile station in which a same cell identifier is set and which are in communication in the macro cell becomes shorter than a threshold,
notifying the first mobile station of a cell identifier in the phantom cell by the radio base station by sending a connection reconfiguration signal; and
setting, by the first mobile station, the notified cell identifier in the phantom cell in addition to a cell identifier in the macro cell.

3. A mobile communication method, comprising the step of:
when a phantom cell formed by linking a plurality of small cells is established in a manner as to at least partially overlap a coverage area of a macro cell under control of a radio base station, starting a non-contention based random access procedure by a mobile station in communication in the macro cell and by the radio base station;
notifying the mobile station of a cell identifier in the phantom cell by sending a random access response signal by the radio base station in the non-contention based random access procedure; and
setting, by the mobile station, the cell identifier in the phantom cell in addition to a cell identifier in the macro cell.

4. A mobile communication method, comprising the step of:
when a phantom cell formed by linking a plurality of small cells is established in a manner as to at least partially overlap a coverage area of a macro cell under control of a radio base station, and when a distance between a first mobile station and a second mobile station in which a same cell identifier is set and which are in communication in the macro cell becomes shorter than a threshold,
starting a non-contention based random access procedure by the radio base station and the first mobile station;
notifying the first mobile station of a cell identifier in the phantom cell by sending a random access response signal by the radio base station in the non-contention based random access procedure; and
setting, by the first mobile station, the notified cell identifier in the phantom, cell in addition to a cell identifier in the macro cell.

5. A radio base station, comprising:
a transmission unit configured to, when a phantom cell formed by linking a plurality of small cells is established in a manner as to at least partially overlap a coverage area of a macro cell under control of a radio base station, notify a mobile station in communication in the macro cell of a cell identifier in the phantom cell by sending a connection reconfiguration signal.

6. A radio base station, comprising:
a transmission unit configured to, when a phantom cell formed by linking a plurality of small cells is established in a manner as to at least partially overlap a coverage area of a macro cell under control of a radio base station, and when a distance between a first mobile station and a second mobile station in which a same cell identifier is set and which are in communication in the macro cell becomes shorter than a threshold, notify the first mobile station of a cell identifier in the phantom cell by sending a connection reconfiguration signal.

7. A radio base station, comprising:
a transmission unit configured to, when a phantom cell formed by linking a plurality of small cells is established in a manner as to at least partially overlap a coverage area of a macro cell under control of a radio base station, start a non-contention based random access procedure with a mobile station in communication with the radio base station in the macro cell and notify the mobile station of a cell identifier in the phantom cell by sending a random access response signal in the non-contention based random access procedure.

8. A radio base station, comprising:
a transmission unit configured to, when a phantom cell formed by linking a plurality of small cells is established in a manner as to at least partially overlap a coverage area of a macro cell under control of a radio base station, and when a distance between a first mobile station and a second mobile station in which a same cell identifier is set and which are in communication in the macro cell becomes shorter than a threshold, start a non-contention based random access procedure with the first mobile station and notify the first mobile station of a cell identifier in the phantom cell by sending a random access response signal in the non-contention based random access procedure.

9. A mobile station, comprising:
a reception unit configured to, when a phantom cell formed by linking a plurality of small cells is established in a manner as to at least partially overlap a coverage area of a macro cell under control of a radio base station, and when the mobile station is in communication in the macro cell, acquire a cell identifier in the phantom cell from the radio base station via a connection reconfiguration signal; and
a setting unit configured to set the cell identifier in the phantom cell in addition to a cell identifier in the macro cell.

10. A mobile station, comprising:
a reception unit configured to, when a phantom cell formed by linking a plurality of small cells is established in a manner as to at least partially overlap a coverage area of a macro cell under control of a radio base station, when the mobile station is in communication in the macro cell, and when a distance to another mobile station, in which the same cell identifier as that of the mobile station is set, becomes shorter than a threshold, acquire a cell identifier in the phantom cell from the radio base station via a connection reconfiguration signal; and
a setting unit configured to set the notified cell identifier in the phantom cell in addition to a cell identifier in the macro cell.

11. A mobile station, comprising:
a reception unit configured to, when a phantom cell formed by linking a plurality of small cells is established in a manner as to at least partially overlap a coverage area of a macro cell under control of a radio base station, and when the mobile station is in communication in the macro cell, start a non-contention based random access procedure with the radio base station, and acquire a cell identifier in the phantom cell from the radio base station via a radon access response signal in the non-contention based random access procedure; and
a setting unit configured to set the cell identifier in the phantom cell in addition to a cell identifier in the macro cell.

12. A mobile station, comprising:
a reception unit configured to, when a phantom cell formed by linking a plurality of small cells is established in a manner as to at least partially overlap a coverage area of a macro cell under control of a radio base station, when the mobile station is in communication in the macro cell, and when a distance to another mobile station, in which the same cell identifier as that of the mobile station is set, becomes shorter than a threshold, start a non-contention based random access procedure with the radio base station and acquire a cell identifier in the phantom cell from the radio base station via a random access response signal in the non-contention based random access procedure; and
a setting unit configured to set the notified cell identifier in the phantom cell in addition to a cell identifier in the macro cell.
